(19) United States
(12) Patent Application Publication
(10) Pub. No.: US 2015/0058409 A1
(43) Pub. Date: Feb. 26, 2015

(54) ENHANCED CONTENT DELIVERY SYSTEM AND METHOD SPANNING MULTIPLE DATA PROCESSING SYSTEMS

(71) Applicant: Frank C. Wang, Boca Raton, FL (US)

(72) Inventor: Frank C. Wang, Boca Raton, FL (US)

(21) Appl. No.: 14/529,234

(22) Filed: Oct. 31, 2014

Related U.S. Application Data
(63) Continuation-in-part of application No. 13/848,896, filed on Mar. 22, 2013.

(51) Int. Cl. H04L 29/08; H04L 29/06

(52) U.S. Cl. CPC H04L 67/327; H04L 67/42; H04L 67/1023
USPC 709/203

(57) ABSTRACT

An enhanced content delivery system and method for use with plurality of digital multimedia data processing systems and legacy systems spanning across one or more network environments. The system and method enable users with freedom of mobility while maintaining access to the user's selected content while the user transitions from one device in one location to a different device in a difference location, substantially without interruption and without the need for user action to turn on and off these target data processing systems. The Instant Invention can provide high bandwidth content delivery solutions based upon hardware and software components by activating a Target device while the system is proximate to the Target device and, in one embodiment, automatically redirecting the content while the system is proximate to a new Target device without user intervention. The Target devices include digital multimedia data processing systems and legacy systems including, but not limited to, HDTVs, TV, Personal Computers, digital music systems, printers, radios, and fax machines.

### CROSS REFERENCE TO RELATED PATENT

The present invention is a continuation-in-part of a previously-filed and currently co-pending patent application entitled “Content Delivery System and Method” filed Mar. 22, 2013 as Ser. No. 13/848,896 by inventor Frank C. Wang.

The present invention is also related to a previously-filed patent application entitled “Content Delivery System and Method” filed Jan. 14, 2011 as Ser. No. 12/930,727 by inventor Frank C. Wang and issued as U.S. Pat. No. 8,412,798 on Apr. 2, 2013.

The present invention is also related to a previously-filed and currently co-pending patent application entitled “Content Delivery System and Method Spanning Multiple Data Processing Systems” filed Oct. 3, 2009 as Ser. No. 12/573,106 by inventor Frank C. Wang.

The specification and drawings from each of these previously-filed patent applications are specifically incorporated herein by reference. Applicant claims the benefit of each of these previous filings under 35 USC 120.

### FIELD OF THE INVENTION

This invention relates generally to a content delivery system and method for enabling a user's freedom of mobility while maintaining access to “real-time” on-going content without substantial interruption to the content delivery and without requiring user intervention; even as the user transitions from one physical location where the content is accessed from multimedia data processing system (referred to as Target device herein) on one network environment to the next physical location with different Target device on a different network environment. More particularly, the present invention improves content delivery between a Smart personal device and a plurality of Target devices while reducing power consumption of the devices; and being able to pull desirable content from the Target devices including but not limited to contents located on a single network location, on multiple network locations, and content hosts located over the internet.

### DESCRIPTION OF THE BACKGROUND ART

Technology has brought us the personal computer (PC), HDTV, Digital personal Multimedia player, Personal Video Recorder, Smart Phone . . . however in our daily interaction with these analog and digital Target devices we are still limited under the current model of being tied down to the physical location of each of these devices, i.e. the content is being delivered from a content host to a target device rather than the delivered content being accessed by user within proximate to the given target device whereas the contents are either stored, displayed, or being sourced from the target device. The physical distance limitation restricts a user to sit in front of a target device such as PC, sitting around a TV and PVR to watch a TV content, which severely limits our freedom of mobility especially when a user may have multiple TVs and multiple work environments in one location. The content is delivered to each physical device by plurality of ways is another limitation in that a HDTV devices can receive contents from Cable, antenna, satellite dish, USB, Ethernet LAN, Wireless LAN. Even when devices receive content via a similar source, each device would need to be interface and programmed individually. Another limitation is that contents are only accessible on each physical target device with its own unique user interface or being able to remote controlled. User has to learn the user interface and or control buttons of each device to operate from simple turning on and off to gaining access to the content of a selected device. Another drawback from the current content delivery and accessing model is wasted energy and bandwidth requirements. With multiple target devices around a home or office, we have to turn on a device when we desire to operate or access the contents upon entering its surrounding location. Frequently we have these devices turned on in multiple locations so a user can be mobile from one location to another, using transmission bandwidth for each unit even though a user is no longer proximate to the device. Another drawback from the current content accessing model is that the content to be access by the user are store either within these target devices or close by the physical device itself i.e. a home entertainment center including a TV, a DVR, a music system . . . etc. As a result, plurality of remote control devices might be implemented to provide users with access to content and operations with all devices located proximate of each other. We are well aware of the inconvenience of plurality of remote devices around a given location. The inefficiency in the current model produces undesirable side effects such as in the case of leaving the devices turned on, which include wasted electricity, running up the usage of the devices thus reducing the useful life and dealing with the heat generated by the devices. In addition, managing multiple user interfaces and remote controls for each of the devices is time-consuming and can be frustrating. Another undesirable side effect is the potential of interference of these devices on wireless networks amongst each other. One of the disadvantages from the user's perspective is the inherent deficiency in the physical range limitation of device centered sourcing and control, which prohibits the continuity of operations and content access and delivery when user physically moves from one location to another.

Accordingly, the prior art systems for delivering and accessing content from these target devices have significant disadvantages and limitations. It would, therefore, be highly desirable to employ a mobile smart personal device which can eliminate the problems of the conventional process and allows users to have freedom of mobility while delivering and accessing the desired contents spanning multiple Target devices without interruption and without requiring user intervention.

### SUMMARY OF THE INVENTION

A Smart personal device is a digital Device which can discover, register, activate, deliver content and deactivate of a plurality of Target devices including but not limited to HDTV, PVR, PMP, PC, DVR around a home, office, hotel room, conference center as described herein. The Smart personal device can be embedded within a digital device including, but not limited to, a smart phone, a personal computer, a laptop, a netbook, a GPS, a personal multimedia player, video MP3 player, a portable radio or a tablet PC.

The Smart personal device is used to first discover multiple Target devices upon identifying one or more Target device(s) located proximate to the Smart personal device. The present invention uses RFID solution for discovering Target devices around one or more physical locations, although it is not limited to a specific communication technology in the future (i.e. wireless USB, wi-fi, RF, FM, Cable, etc.). Once a Target device is discovered and registration steps are completed, the Target device in one embodiment to be placed in a sleep mode if the Target device is not being used by a user or there is no Smart personal device is in proximate to the Target device. Upon the Smart personal device identifying one or more Target device located proximate to the Smart personal device and based on the desired state of the Smart personal device, it will automatically wakeup and activate one or more of the Target devices and deliver content to the Target device to meet the need of the user. These include but not limited to receive and display contents from the Personal Smart Device as in the case of a HDTV, receive and play contents from the Smart personal device in the case of a digital speaker system, receive and display contents of an application as in the case of a personal computer. When the Smart personal device is no longer proximate to the Target device, the Target device will be deactivated by the Personal Smart Device and resume its sleep mode.

The present invention is a system and method which enable a mobile smart personal device to store and deliver content to a target device which is proximate to and activated by one smart personal device selected from plurality of target devices. The content delivery system and method may comprise the smart personal device and a target device alone or in combination with a third content host device whereby the content is first deliver from the content host device to the smart personal device then from the smart personal device to the target device either in real time or using a store and forward method if the target device is not accessible.

The present invention is a system and method which overcomes the limitations and disadvantages of the prior art by providing a simple and convenient way of allowing a user with freedom of mobility and to move from one environment to another while continually accessing his content without interruption.

### BRIEF DESCRIPTION OF THE DRAWINGS

The aforementioned and other features and objects of the present invention and the manner of attaining them will become more apparent; and the invention itself will be best understood by reference to the following description of a preferred embodiment taken in conjunction with the accompanying drawings, wherein:

FIG. 1 is a block diagram of a prior art system location-based digital multimedia Target devices including HDTV, music system, personal computer (PC) for possible use in conjunction with the system and method of the present invention;

FIG. 2 is a block diagram of the exemplary system embodiment of a Smart personal device and Target device communication environment which is used in accordance with the present invention;

FIG. 3 is a block diagram of the exemplary system embodiment of a Smart personal device which is used in accordance with the present invention;

FIG. 4 is a flow diagram of the Instant invention illustrating a selected flow of interaction between a Smart personal device and a Target device;

FIG. 5 is a block diagram of the exemplary system embodiment of a Smart personal device and multiple digital multimedia devices which are enabled with Direct I/O described in accordance with the present invention;

FIG. 6 is a flow diagram of the Instant invention illustrating one flow of interaction of a Smart personal device transitioning from a first Target device in one location to a second Target device in a different location;

FIG. 7 is a block diagram of the exemplary system embodiment of a Smart personal device and a remote Internet content host which are enabled with Direct I/O content Pull mode in accordance with the present invention;

FIG. 8 is a flow diagram of the Instant invention illustrating one flow of interaction between a Smart personal device using a PULL mode with remote content host and local multiple Target devices.

FIG. 9 shows a file structure useful in practicing a method for keeping track of those portions of the selected content which have been delivered and/or performed and those portions of the selected content which have not been delivered and/or performed.

### DETAILED DESCRIPTIONS OF PREFERRED EMBODIMENTS

Before describing the preferred embodiment in detail, a description of some of the terms used herein may assist the reader to understand the present invention.
DISCOVERY: The Smart personal device enables a user to select a discovery mode from which the Smart personal device will discover Target devices by searching target devices in the proximity of the smart personal device which are capable of being interacted by the Smart personal device. The discovery method currently contemplated comprises, but is not limited to, using any one or more of the following: RFID, wireless, powerline, FM, LAN, USB, Bluetooth, Bluetooth Low Energy (BLE or Bluetooth Smart) or any past, current or future standard of networking communication media. The preferred embodiment of the present invention is described in the context of discovering a Bluetooth, BLE, motion sensing, wifi, cellular and/or RFID based devices which is built within or associated with each Target device while a Smart personal device is located proximate to the Target device and/or accessible using any of the above current and future communication protocols. During the discovery process, the Smart personal device initiates all its tasks and performs all functions while Target device can be passive and its main electronics other than the minimal components may be powered off or in low power sleep mode other than the minimal functions including but not limited to the RFID and Wake on LAN or Wake on USB or any of the above communication methods. Once the Smart personal device identifies a suitable Target device located proximate to the Smart personal device which could be remotely accessible by the smart personal device, it will register the Target device such as TV, HDTV, DVR, Music systems and its functional characteristics as content of indications of target devices in the Smart personal device's indications of target device database. The Smart personal device at its option, depending on its programming and user and/or system preferences and requirements may perform a quick test to confirm the Target device's capability even if the Target device is in active operation without disrupting any user action to confirm the Target device's capability. During the quick test, If the Target device is powered off or in a low power sleep state, the Smart personal device can wake up the Target device by using an industry standard method including but not limited to wake on LAN or wake on USB method or any future industry standards. The Smart personal device is capable to perform rediscovery update operation either upon user's selection or perform at a fix interval to detect if there is any new Target device since the last discovery operation. If a new Target device is discovered the Smart personal device will alert the user and enable the user to choose to ignore or to add the newly discovered Target device to the indications of target devices database. A Target device may include a configuration option for not be discovered or only be discovered and registered by if the Smart personal device meets certain parameters including but not limited to authorize by user, by device type, by password, by functionality.
REGISTRATION or REGISTERING: Upon a successful discovery of a Target device, the Smart personal device is capable of registering relevant characteristic of the Target device, by storing relevant information as elements in the indications of target devices database in a storage area under control of the smart personal device. The present invention effects target devices which are predetermined, registered and stored in the indication of target devices database of the smart personal device. A portion of the indications of the Target devices database content may include but not be limited to brand, model, maker, MAC ID, CPU speed, main memory size, disk storage size and type, network capability, smart Direct I/O capability, GPS location, input I/O type, output I/O type; another portion of the indications of the Target devices database include remote control signals may affect a user and its surrounding environment when the smart personal device send these signals to the target devices. This portion of the indications of target devices database content could include but not limited to wake-up, sleep, power-on, power-off . . . etc.; another portion of the indications of the Target devices database content, when communicated between the target device and the smart personal device, may include signals could bring a change to affect the user's sensory systems which comprises vision, hearing, touch, taste, smell, temperature, humidity, sound, air movement, balance/movement and health related characteristic. For example: the smart personal device is capable to remotely control one of more of Target device by sending to the Target device one or more of the indication of the Target device which affect user's surrounding environment by directly and/or indirectly by changing its temperature, ambient lighting, humidity, background sound at a particular time and location. Yet another portion of the indications of the Target devices database content may include signals of personal health, when communicated between the Target Device and the smart personal device may directly or indirectly affect user's health and wellness. This may include but not limited to signals related to heart rate, blood sugar level, body temperature, blood pressure level . . . etc.

When the smart personal device is proximate to a Target device for a first time, the smart personal device could search and discover one or more of the Target devices by communicating with the Target device and once the target device is identified by the smart personal device the smart personal device stores the target device's one or more indications as content in the indications of target devices database in the storage area.

While the smart personal device is proximate to the Target device, the smart personal device could monitor one or more these indications of the Target devices to determine if there is any change to the status from what has previously stored. Some of the status may dynamically change over time. i.e. temperature controls and current temperature indication. The smart personal device is capable of taking action by storing the changed status as updates to the indications of target devices database in the storage area. Once the smart personal device is transported and no longer proximate to the Target device, the smart personal device may update a history of the indications of the Target devices database and store the latest state of the status in the proper portion of the indications of target devices database in the smart personal device prior to suspend the communication with the Target device. When the smart personal device is proximate to the Target device again thereafter, the smart personal device could resume communicate with the target device by retrieve and resuming from the last saved status of the indications of the Target devices database.

The present invention enables the smart personal device of to update a common element to the indication of target devices database while the smart personal device is proximate at a first target device at a first time and deliver the last update of the common element from the first target device to a second target device while the smart personal device is proximate to the second target device. This is done by creating a “snapshot and capture” of the current state of environment and update the common element by storing the captured data in the Indications of target devices database prior to suspend the communication of the current target device. The update setp is for the express purpose to be able to resume from the “snapshot” or “captured” state in a different time and space with a different Target device and a different location or by returning to the same target device and same location at a later time. Each snapshot, could be reviewed and approved by the user, or it could be used as a new update to a list of elements in the database. For example, a user in a living room and the smart personal device activates monitors and controls a smart ceiling fan coupled with a lighting fixture of a first Target device. The user is content with the current environment including temperature, ambient lighting, provided by the first Target device in the living room and desire to suspend (by taking a snapshot and capture) the current state and resume the current state in a family room. The family room also has smart ceiling fan with a lighting fixture as a second target device however it could be made by a different manufacture with similar remote control parameters of ambient lighting and temperature control capability. The present invention enables the smart personal device to monitor the personal preference parameters and take a snapshot of the current state of environment and suspend the current state prior to the user/smart personal device is moving away from the living room to the family room. For example, when the smart personal device detects that it is no longer proximate to the first smart Target device, the smart personal device first snapshot and capture the current state and stored the captured data comprises of at least of temperature and ambient lighting parameter as an update to the indications of the first target device database and thereafter suspend the first target device. Upon detecting the presence of the second target device in the family room, the smart personal device activate the second target device and resume the previously environment by delivering one of more of the previously captured data to the second target device in the family room.

Once registered, the Target device is available to be woken from a low power sleep state and ready to perform operation upon command including but not limited to receive and display content or to transfer content to the Smart personal device. The present invention uses the Smart personal device to perform all the necessary discovery and registration tasks independent of the Target device while the Target device is passive or in a low power sleep mode. In an alternative embodiment, the discovery and registration steps can be easily performed with active participation by the smart personal device and Target device. In one embodiment of a related invention the Target device performs the role of Discovery and Registration whereby the Target device identifies a Smart personal device located proximate to the Target device and performs all operations to discover and register the Smart personal device while the Smart personal device is passive till the Target device activates the Smart personal device.
ACTIVATION: Once the Smart personal device identifies a Target device located proximate to the Smart personal device and confirms in the configuration table that it is a valid and registered Target device, it will automatically perform a wakeup commands to the Target device without the awareness of the user. In addition, if the Smart personal device is being used by the user to perform an ongoing live operation including but not limited to a Windows or MAC or Google application such as word processing, windows office, playing music, video playback, TV broadcasting program, internet related operations such as search, news, blogs, purchase, etc., the Smart personal device will command the Target device to instantaneous switch from the low power sleep state to an active state to perform I/O operations on the Target device. The present invention will enable the Target device, if it's already performing an operation, to automatically perform a split screen if the Target device includes a display unit and has the split screen capability. One or more Target devices may be activated at the same time within proximate to the smart personal device, i.e. PC and printer, HDTV and DVR.
DELIVERY CONTENTS: Selected Content is delivered from the host device to the smart personal device, or from selected content stored in the storage area under control or accessible of the Smart personal device to one or more Target devices, or from selected content of host device to the smart personal device and thereafter transfer the selected content from the smart personal device to one or more target devices activated by the smart personal device based on proximity via various means including but not limed to wireless Ethernet 802.11 G/B/N/A, USB wireless, mobile phone wireless, power line, RF, FM etc., e.g. using industry standards or proprietary communication method(s). In the present invention the selected content may comprise at least one or more of portions of the indications of target devices database described in prior sections and digital content selected by the user include but not limited to a MP3, video, podcast, music . . . etc. for example the smart personal device, is capable of delivering the selected content comprises only one or more portions of indications of target devices database content without including a digital media.

In the present invention, content is transferred between source and a target. The source may include smart personal device, one or more of the target devices, one or more content hosts, one or more portion of the selected content; and the target may include smart personal device, one or more of the target devices, one or more content hosts, one or more portion of the selected content. for example: in one of the invention embodiment of continuation of content playback spanning multiple target devices based on proximity while the smart personal device transitioning from one target device to another target device, the smart personal device accesses both selected content (the source) and a target device (the target) by delivering and rendering the selected content to the target device. Whereas in another invention embodiment of continuation of content creation spanning multiple devices based on proximity, the a first portion of the selected content (the target) is accessed and information is stored by the smart personal device (the source) and later a second portion of the selected content (the target) is accessed and information is stored by a target device (the source) when the target device is proximate to the smart personal device.

The smart personal device in the present invention could use a proximity sensor to deliver a selected content when a proximity sensor device detects the presence of a target device, which has been previously searched, discovered, registered and stored in the indication of target device database of the smart personal device. The proximity sensor device could be included in the smart personal device, or in the target device or in the proximity of the target device and the smart personal device when the smart personal device is in the range of the proximity sensor device. In the present invention the smart personal device may use various sensor devices to enhance a user's freedom of mobility this includes but not limited to the proximity sensor devise, temperature sensor device, lumination or ambient light sensor device, accelerometer sensor device, three-axis gyro sensor device, fingerprint identity sensor devise, barometer sensor device, air pressure sensor device, heart rate sensor device, glucose sensor device or any future sensor technologies. Each of the sensor device as illustrated before could be included with the smart personal device or with a target device or outside of the smart personal device and in the vicinity near a target device. Regardless of the physical location of these sensor devices, the smart personal device is able to communicate with one or more of these sensors when in range to bring a new level of mobility, efficient, effectiveness and flexibility to the user.

In a preferred embodiment of the present invention, in order to achieve a desired state (such as near seamless, non-interrupted content delivery user experience) while the smart personal device is moving from a first location with a first target device to a difference second location with a difference second target device, the smart target device is enabled to not only deliver, perform, render content only while it is proximate to the first target device but also effective using a map showing those portion of the selected content which have been delivered, performed, rendered and those selected content which have not been delivered. The map may apply to the smart personal device deliver content within itself i.e. from its own intelligent storage i/o unit to its display unit or one of more target device which the smart target device has activated only while a proximity device within the smart target device identifies and activates the target device. A communication device within the data processing system which delivers portions of a selected content to the first target device and update the map of the portions of the selected content have been delivered only while the data processing system is proximate to the first target device; the communication device also delivers the selected content to the second target device which have not been delivered to the first target device only while the data processing system is proximate to the second target device. Furthermore in the prefer embodiment of the present invention the smart personal device also is enable through its communication device and the communication device of the target device to maintain a map showing those portions of the selected content which have been delivered, or performed, or rendered and those portions of the selected content which have not been delivered, or performed, or rendered. This enables the smart personal device once leaving the first target device of the first location and identifying and activating the second different target device of the different second location to start deliver selected content which have not been delivered, or performed, or rendered by the first target device to ensure seamless and non-interrupted content delivery user experience. Additionally, if more then on target device are identified by the proximity device in a location, the smart target device may enable the user to select a prefer target device to activate or simply to activate the most recently activated target device from the detected list

In one embodiment of content delivery methods of the present invention, the selected content stored on a host device is being pulled by the smart personal device and thereafter the selected content being pushed from the smart personal device independent of user interventions to one or more of the input unit controller of the target device which is proximate to and activated by the smart personal device from plurality of target devices. The host device, the smart personal device and the selected target device may be coupled on the same network segment or on different network segments. In addition, the received selected content by the smart personal device maybe pushed to the target device either near “real-time” with minimal delay, or as soon as a portion of the selected content is received by the smart personal device (i.e. the smart personal device is simultaneous receiving new portions of selected content from the host device and transfer the received portions of the selected content to the target device) or the selected content maybe stored on a storage area either on the smart personal device or can be accessed by the smart personal device if the target device is not ready to received.

In another embodiment of content delivery methods of the present invention, the selected content stored on a host device is being pulled by the smart personal device and thereafter the selected content being pulled, by a user intervention, from the smart personal device by one of the input unit controller of the target device which proximate to and activated by the smart personal device from plurality of target devices. The host device, the smart personal device and the target device may be coupled on the same network segment or on different network segments. In addition, the received selected content by the smart personal device maybe pulled by the target device either near “real-time” with minimal delay or as soon as a portion of the selected content is received by the smart personal device (i.e. the smart personal device is simultaneous receiving new portions of selected content from the host device and transfer the received portions of the selected content to the target device) or the selected content maybe stored on a storage area either on the smart personal device or on a storage area accessible by the smart personal device if the target device is not ready to receive.

In a different embodiment of the content delivery methods of present invention, the selected content stored on a host device is being pushed, independent of use interventions, to the smart personal device and thereafter the selected content being pushed, again without user interventions, from the smart personal device to one of the input unit controller of the target device which proximate to and activated by the smart personal device from plurality of target devices. The host device, the smart personal device and the target device may be coupled on the same network segment or on different network segments. In addition, the received selected content by the smart personal device maybe pushed to the target device either near “real-time” with minimal delay or as soon as a portion of the selected content is received by the smart personal device (i.e. the smart personal device is simultaneous receiving new portions of selected content from the host device and transferring the received portions of the selected content to the target device) or the content maybe stored on a storage area either on the smart personal device or on a storage area accessible by the smart personal device if the target device is not ready to receive.

In a yet-different embodiment of the content delivery method of present invention, the selected content stored on a host device is being pushed, (i.e., without user intervention), to the smart personal device and thereafter the pushed content is pulled from the smart personal device by one of the input unit controller of the target device which proximate to and activated by the smart personal device from plurality of target devices. The host device, the smart personal device and the target device may be coupled on the same network segment or on different network segments. In addition, the content received by the smart personal device may be pulled by the target device either near “real-time” with minimal delay or as soon as a portion of the selected content is received by the smart personal device (i.e. the smart personal device is simultaneous receiving new portions of selected content from the host device and transfer the received portions of the selected content to the target device) or the content maybe stored on a storage area either on the smart personal device or on a storage area accessible by the smart personal device if the target device is not ready to receive. If the Target device is a HDTV, the input unit controller is capable of receiving content from input source including but not limited to antenna, cable, wireless LAN, RF, FM, LAN, wireless USB. If HDTV comprises a HDTV Core Media Processor than its CPU, main memory, output unit controller will be activated to receive the content being pushed from the Smart personal device using its input unit controller, transmit the content to the CPU/main memory using the I/O BUS. After the CPU process the content, it will transfer the content to the output unit controller using the I/O BUS and the output unit controller will display the content on the Target device. In this embodiment, the majority of the digital logic will be powered to perform the function.

In another embodiment, whereas the Target device comprising smart input I/O controller and smart output I/O controller, once the Target device is being activated by the Smart personal device and properly configured by the Direct IO manager of the Target device, the smart input I/O unit controller is capable of receiving bulk streaming content from the Smart personal device and deliver the bulk streaming content directly to the output I/O unit controller using the I/O BUS independent of the Core Media Processor and Main Memory. In addition, in this embodiment of Direct I/O method, the Core Media Processor and Main Memory can be turned off or to be in a low power sleep mode thus significantly reducing power required for the operation. This Direct I/O method may be enabled in devices including but not limited to HDTV, Music systems, Personal Computers or Target device comprising at least one smart Input unit controller, one smart storage unit controller and one smart output unit controller.

In another embodiment, when the Smart personal device is leaving proximate of one Target device and arriving at a proximate of different Target device, the Smart personal device upon detection of it is no longer proximate to the first Target device, it will deactivate the first target device and it may store the content in a temporary buffer or a storage unit or to suspend the content delivery to the Target device by maintaining a map of the portions of the selected content is delivered, the portions of the selected content is both delivered and rendered/performed by the target, and the portions of the content is not delivered to the first target device using the intelligence on the Smart personal device unit. Upon identifying a new Target device or back to the original Target device located proximate to the Smart personal device, it will first deliver the content from its temporary buffer or storage unit therefore there is no interruption or loss of the content while the user is transitioning from one Target device location to the next by resuming the content delivery by using the map to determine to either from the portions of the content is delivered or from the portions of the content is both delivered and rendered/performed by the target device.

The present invention describes content delivery from the Smart personal device to push content to a first HDTV Target device and redirect the content and push the remaining content to a second HDTV Target device whereby the Target device located proximate to the Smart personal device. In another embedment of the present invention the Smart personal device is receiving a live digital FM broadcasting contents while delivering the FM broadcasting contents to a digital speaker system (Target device #1) in a home location on network #1. When the user is leaving the above described home location and entering in a second location i.e. an automobile with a digital speaker system, the Smart personal device will first deactivate the first Target device on network #1 when the first Target device is no longer proximate to the Smart Personal Deice (the first time), automatically start storing or recording the content from the FM broadcasting on its storage unit. Upon identifying the digital speaker system (Target device #2) in the automobile on network #2 located proximate to the Smart personal device (the second time), it will activate the Target device #2 and resume the content delivery from the previous stored content while continuing storing or recording the current FM broadcasting content. In the above embodiment, the network #1 whereas the Smart personal device and the Target device communicate by means may include but not limited to a wireless Ethernet network. However the network #2 is a different network from the network #1 whereas the Smart personal device and Target device #2 communicate by means may include but not limited to a Bluetooth network.

In yet another embodiment, the Smart personal device upon user's selection is capable of waking up one of more Target devices from the low power sleep state and performs content search operation of its neighboring Target devices which has been enabled for such actions. Once the matching criteria is found, the Smart personal device will “pull” such content from its neighboring Target devices and store on the local storage of the Smart personal device without interrupting its current operation of either device. The transfer of the content can be performed using the CPU, memory and the I/O BUS of the neighboring Target devices, or if the neighboring Target device comprises smart I/O controllers, the transfer of content can optionally be performed using a Direct I/O method of transferring content from the smart storage unit I/O controller to the smart network unit I/O controller independent of the Target device's CPU and memory. i.e. during the Direct I/O setup phase, under the program control of its Direct I/O Manager, Direct I/O operation configures resources including source buffers, destination buffers, first party busmaster DMA devices on associated source and destination I/O devices for direct peer transfers, peer I/O interrupt controller associated with the busmaster DMA device to signal from one peer I/O device to the other peer I/O device to transfer one or more sequence of data without any involvement of the host CPU or I/O processor, Direct DMA chaining associated with the busmaster DMA device to self-configure and auto-configure the busmaster DMA device to reload DMA configuration parameter associated the subsequent data segment upon completion of the current data segment. This is critical to perform data movement from one data segment to a next data segment without processor intervention during the entirety of data transfer session. As the results of the above functionalities, content is transferred from the smart storage unit I/O controller to the network unit I/O controller using the I/O BUS independent of its CPU and main memory. Then the network unit I/O controller transfers the content to the storage unit I/O controller of the Smart personal device. The Smart personal device with the smart I/O controller have the option to directly transfer the content from its smart network unit I/O controller to the smart storage I/O unit controller independent of its CPU and main memory operate effective under control of the Direct I/O Manager. The Direct I/O method improves the speed performance and reduces power consumption of the device since the CPU and main memory are not active during the content transfer operation. Upon completion, the Smart personal device will alert the user that such contents are ready for display at user's convenience.

In yet another embodiment, the present invention may, upon its user's command, using “pull” method amongst neighboring Target devices as well as content host Target devices across the internet; instead of having contents, such as web advertisements, being “pushed” onto the Smart personal device without the consent of the user, the Smart personal device will operate effectively to block all non-authorized intrusive contents from displaying on the Smart personal device or target devices without the consent of the user; instead it offers user an option to specify a desire content criteria for the Smart personal device to perform search directly, or indirectly through another intermediary web based service on user's specified criteria. Once the relevant criteria are found, a matched content list will be generated by the Smart personal device to enable the user to review the list at one's convenience. If the user elects to view one or more (or all) of the match content from the list, the Smart personal device is operable effective to PULL the selected content from the storage area of the various content hosts, which may be over the Internet or Target device in its LAN environment. After the completion of the PULL steps, content such as web advertisement is stored onto the storage I/O unit controller of the Smart personal device for display at user's convenience. The present invention using “pull content” method for web advertisements over internet as an example, such invention may apply to a variety of contents over the Internet including but not limited to pull relevant books content, relevant news content, relevant sales contents, relevant advertisement promotion through the use of banners, widgets, etc. and user-specified web target services and information sources including but not limited to google.com, facebook.com, youtube.com, amazon.com, uspto.gov, etc.

In another embodiment of the present invention, with the presence of Internet content host and web based retailers such as ebay.com and amazon.com, there is a prolific presence of web based advertisement, in the forms of banners, widgets, whereby advertisement campaign pushes these contents to device and being displayed on a specific area of the output devices i.e. CRT, LCD, HDTV of a device including but not limited to a smart phone, a personal computer while a user accessing contents from the Internet without consent of the user. Some of these advertisement contents may be interesting to a user however the majority of these web based advertisement are disruptive and each takes away productive time and processing resources away from the user. The present invention overcomes these pushed intrusions by enabling the user to specify a finite set of criteria for the Smart Device including to eliminate these un-authorized contents by removing these contents before deliver the content to the target; to use the specific filter option specified by user to first search relevant content hosts over the Internet directly or using an intermediary web services to do so. Once a desirable content is found, the Smart personal device will build a match content list and store the match content list on the Smart personal device for the user to access at one's convenience. Once a content within the matched list is selected by the user, the Smart personal device will be operated to “pull” these selected content from the content hosts and store the matched content on the storage unit of the Smart personal device for the user to access it at user's convenience either directly on the Smart personal device or access (or “push” these contents on one or more of the Target devices.

In another embodiment of the present invention, the smart personal device may be used to facility locally delivered service actions including installation, configuration, change management, problem determination and fault isolation management tasks in a home or business locations whereas a remote delivered service actions is not effective, not viable or not available. In such locally delivered service environment, a service personnel uses the smart personal device to coordinate service operations between a remote service host over the internet and a service target which is locally present on premises. A cable service company responding to a service call of an internet signal loss to a HDTV or a PC, service personnel is dispatched on site to use the smart personal device to perform problem determination service action locally on the alleged problem on network, and target device may include a HDTV or PC locally to make sure the target device is operational, then use the smart personal device to access contents stored from the internet content host and deliver the contents to the target device to verify that the communication function between the target device and the smart personal device is fully operational.

In one embodiment of the present invention, the smart personal device could select elements from indications of target devices database to communicate with target device and in certain situations the selected elements from indications of target devices could be the only selected content with no other digital media content. The smart personal device may determine element of the indications of the Target devices database could include a common element or a unique element from one target device with another target device. A unique element consists of that the element of the indications of the target devices is different from all other elements of the indications of target devices in the database. Whereas a predetermined common element consists of that the element of the indication of the target device is identical of another element of the indication of target device in the indications of target devices database. For example: the smart personal device discovers a first target device (a smart fan in the family room) and registered the first target device in the indication of target device database includes the following elements in the database: element #1: (Target device #1, temperature setting control element of X′0123″); element #2: (Target device #1, manufacture element of X′ABC″) in the stored indications of target devices database. In addition, the smart personal device discovers a second target device (a different smart fan in the living room). The smart personal device registers stores relevant elements of the second target device includes element #3: (target device #2, a temperature setting control element of X′0123″) and element #4: (target device #2, manufacture element of X′XYZ″) in the stored indications of target devices database. The smart personal device now determines that the first and second target devices share a predetermined common element of element #1 and element #3 as shown by element #1 (Target device #1: temperature setting control element of X′0123″) and element #3 (target device #2: a temperature setting control element of X′0123″) are common. In addition, the smart personal device also predetermines that element #2 (Target device #1: manufacture element of X′ABC″) and #4 (target device #2: manufacture element of X′XYZ″) are unique element within the indication of target devices database since element #2 and #4 is unique to any other elements of the database. The present invention may use this predetermined common element to enhance user mobility with the following smart continuity with suspend and resume capability.

The smart personal device may be enabled with a smart continuity feature with suspend and resume whereas the smart personal device may use the predetermined common elements of indications of target devices database as selected content to automatically suspend a current state of the common element of indication of the first target devices when the smart personal device is no longer proximate to the first target device; and when the smart personal device is transported proximate to a second target device which shared the predetermined common element of indication of the first target device, the smart personal device may automatically, without use intervention, resume the last suspended state of the common elements of indication of the first target device and communicate with the second target deice of the last suspended common elements of the indication of the first target device. This benefits the user to roam freely and effortlessly when the smart personal device is transported from the first target device of a first location to the second target device of a second location. i.e. when the smart personal device is transported and no long proximate to the first target device and suspends the communication of the selected content with the first target device. Thereafter, the smart personal device detecting that the second target device which shared a common element of indication with the first target device is proximate to the smart personal device, the smart personal device resumes to communicate the suspended selected content which comprises the common element of indication of the first target device with the second target device. Another example to show a real life example of smart continuity with suspend and resume: a first target device (wireless music playback system in a home) and a second target device (a sound system in-car entertainment system) shared a common element of indications of sound level for playback and numerous uncommon or unique element of indications i.e. manufacture maker . . . etc; when the smart personal device, proximate to the first target device in the home and communicates a certain sound level for playback from the stored indications of the Target device as a portion of the selected content to the first target device; When the smart personal device is transported away from the first target device, the indication of sound level of playback is suspended. When the smart personal device is transported to the car and proximate to the second target device, the smart personal device resume communication to the second Target device to include the indication of sound level for playback as the selected content with to the second target device. The selected content may comprise at least one of the common indications of sound level for playback and other selected digital contents. In addition, the smart personal device may perform the smart continuity with continuity with suspend and resume totally without user intervention or it may include a user option which enable the user to select which one or more of the common element of indications between Target device to continue by suspend from one Target device at the present time and resume to a second Target device at a future time whereas the sound level for playback is a common element of indications the first and second Target devices.

In another embodiment of content delivery methods of the present invention, the smart personal device is capable of a performing a smart continuity with suspend and resume feature while the smart personal device is transitioning from a first target device to a second target device. This is done by enabling the smart personal device to deliver selected content includes one of more of the indications of the first target devices (i.e. set a prefer target temperature) while the smart target device is proximate to the first target and second target devices. While the smart target device is proximate to the first target device, the smart continuity with suspend and resume feature could dynamically monitor the target level and compare to the actual level; and communicate to the first target device in real time to ensuing the actual level matches or reaches to the target level. When the smart personal device is no longer proximate to the first target device, the smart personal device could suspend the current level and optionally capture the actual level at the time of suspending and store the level at the time of suspending in the indication of target devices database. When the smart personal device is proximate to a second target device which share a common element of indications with the first target device, the smart personal device could resume and restore the level at the time of suspending to the second target device to ensuing continuity of the common element while transition from the first target device to the second target device.

The smart continuity with suspend and resume feature could apply to but not limited to temperature, humidity, lighting, health related blood sugar, heart rate, blood pressure . . . etc. An example of how the smart continuity with suspend and resume feature could apply to a smart home is as follows: a multilevel home includes one room at upstairs level and the room includes a smart ceiling fan (a first target device) with lighting fixture whereas the smart ceiling fan could have 5 fan rotational speed control for the smart personal device to remotely monitor/control based on an expected temperature indication of target device stored on the smart personal device vs actual temperature of the room; and lighting fixture could have 3 lumination level for the smart personal device to remotely monitor/control based on the expected lumination indication of target device stored on the smart personal device vs actual lumination level of the room; at downstairs level has one rooms which includes a smart ceiling fan (a second target device) with lighting fixture whereas the smart ceiling fan could have 5 fan rotational speed for the smart personal device to remotely monitor/control based on the expected temperature level stored on the smart personal device vs actual temperature of the room; and one lighting fixture has 3 lumination level for the smart personal device to remotely monitor/control based on the expected lumination indicator of target device stored on the smart personal device vs actual lumination level of the room; in addition, the first target device and the second target device share common elements of indications of target device including fan rotational speed and lumination level for the smart personal device to remotely monitor/control; the smart personal device includes a proximity sensor device to detect the presence of the first and second target device; and the smart personal device could include a temperature and lumination sensor device to detect the actual temperature level and lumination level proximate to the smart personal device. When the smart personal device is proximate of the first target device at the upstairs location as detected by the proximity sensor device, the smart personal device communicates to the first target device to activate the first target device. This is done by including the selected content with activating the first target device stored in the smart personal device indications of target devices; the smart personal device also communicates to the first target device to adjust the rotational speed and/or lumination level of the smart ceiling fan of the first target device by selecting content of indications of expected rotational speed and/or lumination level a of the first target device based on the expected temperature indicator and/or lumination level indicator stored in the smart personal device based on the actual temperature sensed by the temperature sensor device and/or lumination sensor device included in the smart personal device. While the smart personal device is proximate to the first target device, the smart personal device communicate the selected content of indication of rotational speed and/or lumination level on a continuous, or as needed based on the temperature sensor device and the lumination sensor device. i.e. entering into the room the indication of expected temperature is set to be 70 degrees and the temperature sensor device showed an actual temperature of 90 degrees; the smart personal device could communicates to the first target device to rotate the ceiling fan at the highest speed level of its 5 speed level; as the temperature sensor device detects the actual temperature is reduce to 70 degrees, the smart personal device could communicates to the first target device to rotate the ceiling fan at a reduced speed level from the 5 speed level; when the temperature sensor device detects the actual temperature matched the indication of expected temperature of 70 degrees, the smart personal device could communicates to the first target device to rotate the ceiling fan at a lowest speed of the 5 levels. In the event that the smart personal device is transported away from the first target device and no longer proximate to the first target device, the smart personal device could communicate an indication of deactivate the first target device; suspend the communication of the selected content including but not limited to the indication of expected temperature and lumination level; in addition, could store the current state of actual temperature and lumination in the storage area of the smart personal device. As the smart personal device is transported proximate to the second target device, since the first and second target device shares the common element of indications of activation, deactivation, fan rotational speed level, lumination level . . . the smart personal device could communicate to the second target device, the indication of activation the second target device; to resume the suspended selected content of last rotational speed and/or lumination level of the smart ceiling fan of the first target device using the proximity sensor, temperature sensor and lumination sensor devices.

In another embodiment of the present invention, the smart personal device could carry out the smart continuity with suspend and resume using a predetermined path for a pair of target devices (a first target device and second target device). For example, a first and second target device includes at least a common element (i.e. remote control code for temperature control) and a unique element (i.e. model #) stored in the indication of target devices database. Furthermore a first and second target device is programmed to have a predetermined path for smart continuity with suspend and resume. i.e. from a first target device in the family room to the second target device in the living room. The smart personal device delivers a first portion of the selected content including the common element while proximate to the first target device; Upon detecting the smart personal device is no longer proximate of the first target device; the smart personal device suspends the first portion of selected content which included the common element of the indications of first and second target devices. Upon arriving at the second target device matches the predetermined path, the smart personal device resumes the second portion of the selected content which may include the same common element of indications of first and second target devices and communicate the common element to the second target device. Furthermore, certain predetermined common elements for the smart continuity feature with suspend and resume may be exclusively used between a first target device and second target devices. The exclusively used common element, once being predetermined by the smart personal device between the first and second target devices, is restricted from being applied to any other target devices. The exclusive predetermined common element is unique to the first and second target device and not used by any other target devices such that the smart continuity feature with suspend and resume only apply when the smart personal device transitions from the first target device in a first location to the second target device in a different location.

In another embodiment of the present invention, the smart personal device may be used only as an agent device whereas the smart personal device does not deliver content from the storage of smart personal device but use the proximity device of the smart personal device to suspend and resume the content delivery from the host content device to target devices. The host content device including local content storage units to the smart personal device and target device (i.e. DVR storage unit in home, server storage unit in home . . . ) or remote content storage units over the local area network or over the internet (i.e. content server over LAN, or storage over Cloud service such as iCloud or Amazon). In this embodiment, content device, either over the internet or located proximate to these target devices, delivers and render selected content from content device directly to first and second target devices which are previously discovered, register and stored in the indications of target devices database of the smart personal device only while the smart personal device is proximate to the target devices. Also the selected content is delivered from the content device to the first and second target devices and rendered by the first and second target devices independent of the smart personal device to deliver the content. The smart personal device could be the agent on premises to detect that the smart personal device is proximate to the first target device of the one or more target devices; the content device delivers a first portion of the selected content to the first target device while the smart personal device is proximate to the first target device. In response to the smart personal device is transported away from and no longer proximate to the first target device, the content device suspends the content delivery of the first portion of the selected content; thereafter, in response to the smart personal device is proximate to the second target device of the one or more target devices, the content device delivers a second portion of the selected content to the second target device while the smart personal device is proximate to the second target device whereas the second portion immediately follows the first portion. When the user transports the smart personal device away from and no longer proximate to the second target device, the content device suspends the content delivery of the second portion of the selected content. In another embodiment of the present invention illustrates continuity with suspend resume with a smart personal device and a smart target device both operate, manage, and store information in the selected content based on a proximity: This includes a smart personal device discovered and registered a smart target device and stores smart target device information in the indications of target devices database. At a first time interval, the smart personal device accesses and operates a first portion of a selected content by at least one of storing information or retrieving information in the first portion of the selected content; while the smart personal device is operating the first portion of the selected content, the smart personal device detecting the smart target device of the indications of target devices is no longer proximate to the smart personal device, the smart personal device, may provide a user option, or without use intervention to suspend and ceasing operating the first portion of the selected content; and enable the smart target device to resume access the selected content from where the smart personal device hands off the access and control of the first portion of the selected content. The target device gains access and control of the second portion of the selected content and creating and storing information in the second portion of the selected content whereas the second portion of the selected content follows the first portion of the selected content. In addition, the smart personal device enables the smart target device to resume access the selected content by starting from the second portion of the selected content may be a result of a user option or without user intervention. The smart target device may operate the second portion by at least one of retrieving content or storing information in at least the second portion of the selected content. To further clarify, the smart personal device stores information in the first portion of the selected content (i.e first portion of a word document) and the smart target device store information in second portion of the selected content (i.e. second portion of the word document) after the access of the selected content is transitioned from the smart personal device to the smart target device. Furthermore, after the smart target device gained access to the selected content, the smart target device may store information in at least one of the first and the second portion of the selected content. When the smart personal device detects that the smart target device is no longer proximate to the smart personal device, smart personal device resume access the selected content and continue storing information in at least one of the first portion and second portion of the selected content.
DEACTIVATION: When the Smart personal device is no longer proximate to the Target device, the Target device may automatically be deactivated by the Smart personal device in the present invention so the underlining data processing logic including but not limited to the media CPU, main memory, input and output controllers and associated input and output devices and resume in a low power sleep state. Once the Target device enters in the low power sleep state the only function running under the low power sleep state is the activation detection logic comprising, but not limited to, RFID, proximity sensor, wake on LAN, and wake on USB units. In one embodiment of a related invention, the Target device performs the role of deactivation whereby the Target device identifies a Smart personal device is no longer located proximate to the Target device and performs all operations to deactivate the underlining data processing logic including but not limited to the media CPU, main memory, input and output controllers and associated input and output devices and resume in a low power sleep state.

Having provided a description of some of the relevant terms used in this description, the remaining portion of this section will describe the illustrations of the present invention.

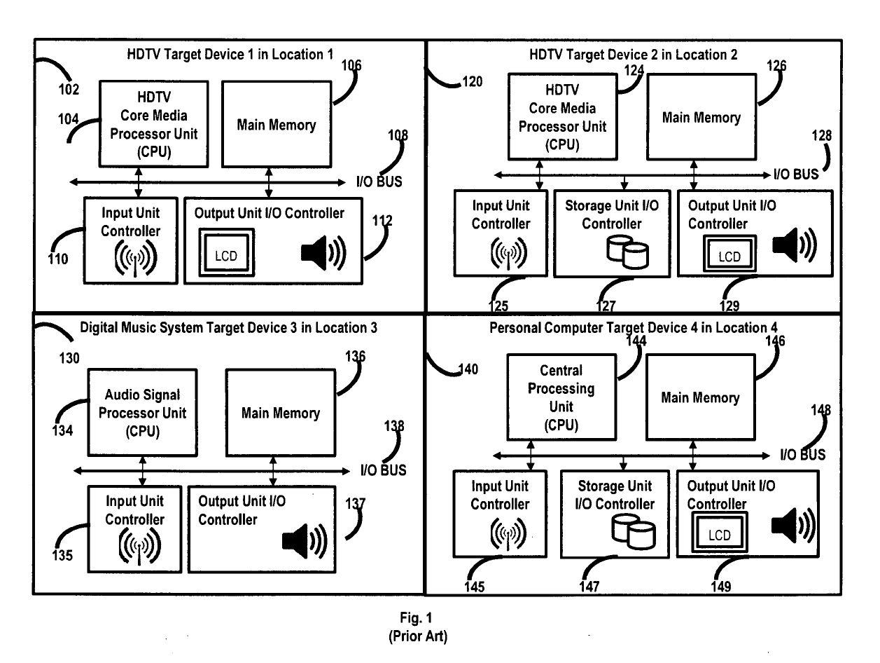

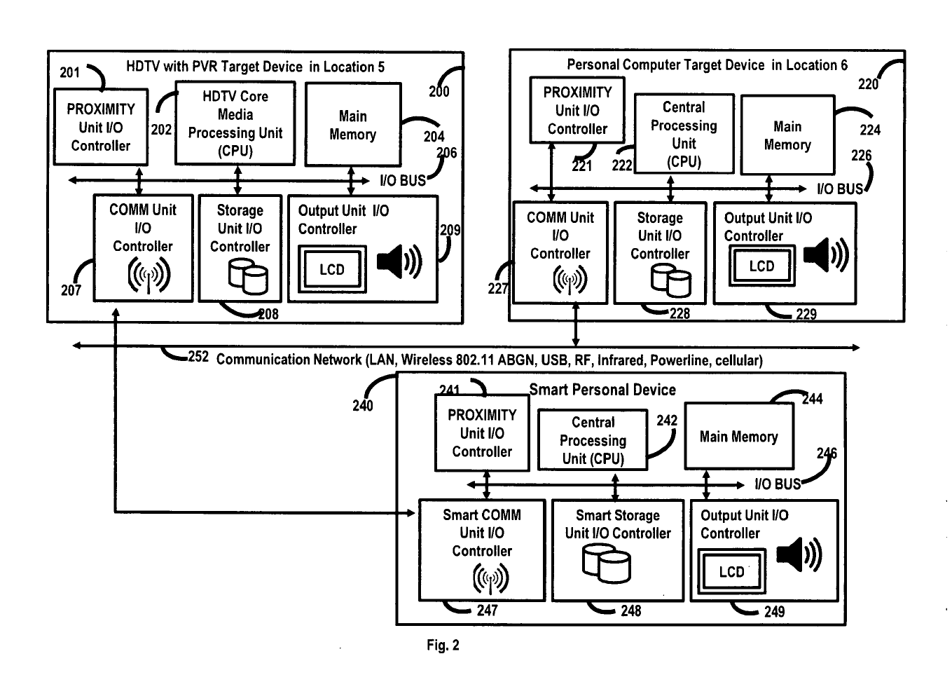

A typical, well-known, system includes one or more Target devices which comprising a plurality of digital multimedia data processing systems within a home environment as a prior art of the present invention that can be used are illustrated diagrammatically in FIG. 1. FIG. 1 illustrates multiple Target devices in different locations and each target device may deliver unique, different content and employ a different user interface to a user. The FIG. 1 comprises a HDTV 1 Target device which is located in room 1 block 102, within block 102 comprises HDTV home Target device 1 is a HDTV where it is physically located in location 1. The HDTV Target device 1 block 102 comprises a HDTV Core Media Processor unit (CPU) 104, main memory unit 106, input unit controller 110, output unit I/O controller and an I/O bus 108 connected to each unit 104, 106, 110, and 112. The HDTV Target device 2, 120 comprises a HDTV Core Media Processor unit (CPU) 124, main memory unit 126, input unit controller 125, output unit I/O controller 129, storage unit I/O controller 127 and an I/O bus 128 which connects by each unit 124, 126, 125, 127 and 129. The Music System Target device 3 130 comprises an Audio Signal Processor unit (CPU) 134, main memory unit 132, input unit controller 135, output unit I/O controller 137, and an I/O bus 138 which connects by each unit 134, 136, 135, and 139. The Personal Computer Target device 4 140 comprises a Central Processor unit (CPU) 144, main memory unit 146, input unit controller 145, storage unit I/O controller 147, output unit I/O controller 149 and an I/O bus 148 which connects by each unit 144, 146, 145, 147 and 149. The input unit controller 110, 125, 135, 145 are capable of receiving signal which comprise the contents from one or more signal sources but not limited TV antenna, wireless Local Area Network (LAN). Each Target device receive contents from the input unit controller, deliver the content to the output unit I/O controller using the I/O bus or at its option with or without the user's option to store the content in its storage unit I/O controller for later delivery. One common characteristic for all Target devices in FIG. 1 is that all contents are received and delivered locally or stored locally at or near the physical presence of the Target device for later access by the user on the Target device apparatus. This restrict a user to access of all or any of the contents within certain fixed physical distance limitation of the Target device FIG. 2 is an exemplary system embodiment of a Smart personal device 240 being used in conjunction with a plurality of Target devices in the present invention.

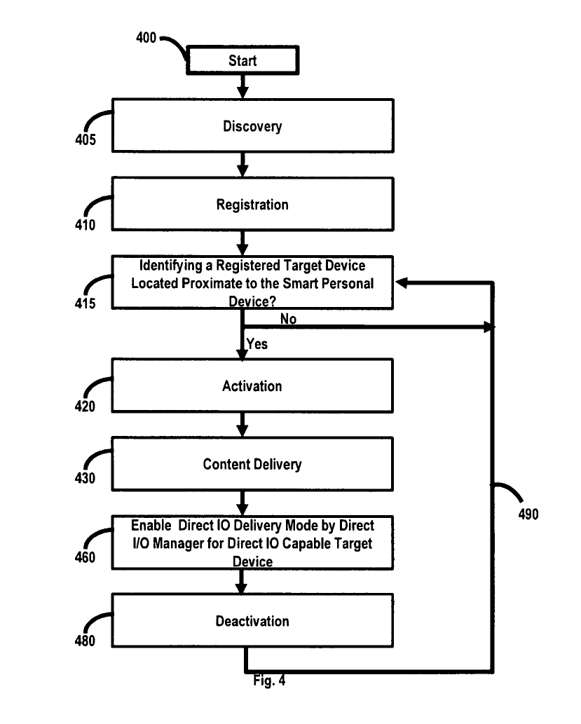

In the illustrated embodiment of FIG. 2 a Smart personal device 240 is connected with a HDTV with DVR Target device in location 5, 200 and a Personal Computer Target device in location 6, block 220 whereas as device 200, 220 and 240 are attached to a network 252. Network 252 in the exemplary system embodiment may include but not limited to a wireless 802.11 ABGN communication network which conforms to a standard communications protocol such as 802.11a, b, g or n, a USB, a RF communication system, an infrared, a Bluetooth, a cellular communication or a powerline-based communication network. The target device in location 5, 200 includes a proximity unit I/O controller 201, a central processing unit (CPU) 202, main memory 204, COMM (Communication network) unit I/O controller 207, storage unit I/O controller 208, output unit I/O controller 209, all of which are interconnected with I/O bus 206. The proximity unit I/O controller 201 of the target device 200 may include a RFID component which enables the smart personal device 204 to perform the discovery, and register steps described above. The remaining functional components 202, 204, 206, 207, 208, and 209 work in conjunction with the Smart personal device 240 to perform the steps of activation, content delivery, deactivation and content pull mode as shown with FIGS. 4, 6, and 8. Within the Target device in location 6, 220, comprising a proximity unit I/O controller 221, a central processing unit (CPU) 222, main memory 224, Comm unit I/O controller 227, storage unit I/O controller 228, output unit I/O controller 229 are interconnect with I/O bus 226 and the proximity unit I/O controller 221 may comprise a RFID component which enables the smart personal device 204 to discovery and register steps of device 220. The remaining functional components 222, 224, 226, 227, 228, and 229 work in conjunction with the Smart personal device 240 to perform the steps of activation, content delivery, deactivation and content pull mode as shown with FIG. 4, 6.

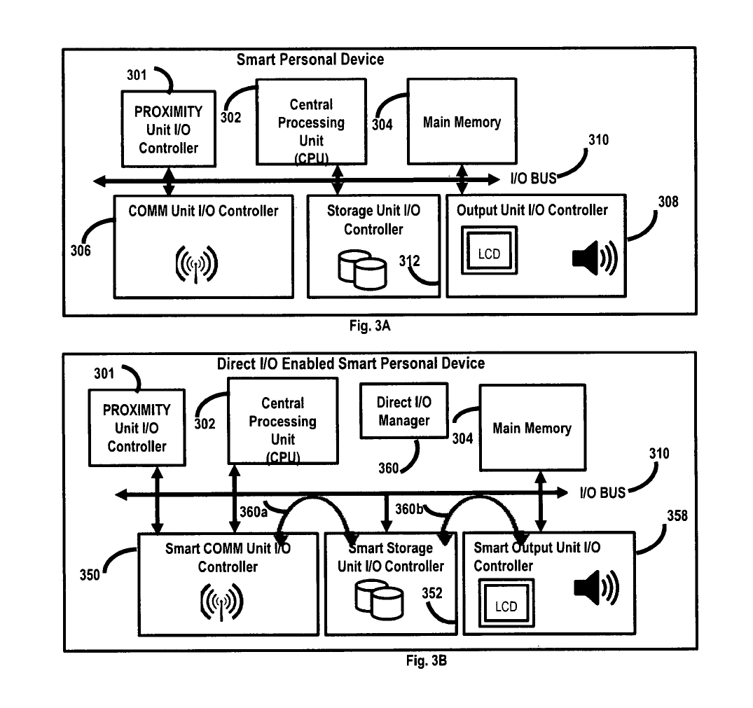

FIG. 3A is an exemplary system embodiment of a Smart personal device to be used in conjunction with a plurality of Target devices in the present invention. In the illustrated embodiment 3A comprises a proximity I/O unit controller 301, a central processing unit (CPU) 302, main memory 304, comm unit I/O controller 306, storage unit I/O controller 312, output unit I/O controller 308 and each units are interconnected with I/O bus 310. The main memory 304 may comprises a static, read only, dynamic RAM whereas the storage unit I/O controller may comprises non-volatile storage including but not limited to IDE, SCSI, SATA, NAND, SD storage types.

FIG. 3B contains the same components 302, 304, 310 as discussed in FIG. 3A with the addition of a Direct I/O manger 360 and smart comm unit I/O controller 350 and smart storage unit I/O controller 352 and smart output unit I/O controller 308. Duo to the high definition and high data rate requirements of these Smart personal device, the I/O units 350, 352, 358 in FIG. 3B of the present invention may including busmaster capability to direct transfer content between the main memory 304 and respective I/O units, independent of the CPU 302 effective under program control using the I/O bus 310; In the event of transferring bulk content i.e. a digital movie, the Smart personal device in FIG. 3B may invoke a Direct I/O transfer mode wherein effective under program control of the Direct I/O Manager 360 to transferring content directly between a pair of said I/O units via said I/O bus as show in 360a and 360b, bypassing the main memory and independent of the CPU. The Direct I/O Manager 360 is operable to enable the Direct I/O Mode under program control for a Target device improves not only the content transfer speed of the Target device but also reduces the power consumption of the CPU and Memory since these units area bypassed and inactive during the duration of entire selected content transfer. FIG. 3B upon set up by the direct I/O manager 360 under program control is operable to directly one of more direct transfer path across the I/O bus 310 and delivery bulk contents from the smart comm unit I/O controller 350 to the smart storage unit I/O controller by transferring the content across once, as shown with data path 360a using the I/O bus 310. The Direct I/O manager 360 is capable of simultaneously enabling one or more such direct I/O operation pair across the I/O bus 310 as shown with data path 360b wherein upon program control of direct I/O manager 360, the smart storage unit I/O controller is capable of transferring bulk data to smart output unit I/O controller once across the I/O bus 310, independent of the CPU 302 and main memory 304. The direct I/O does not increase content delivery data rate but more significantly, by bypassing the CPU 302 and memory 304 while performing the bulk data transfer, it significantly reduces the power consumption of the Target device. The referenced program control under the direct I/O manager 360 is required to intercept the traditional operating system file transfer operation which transfer the selected content between the two smart devices using the memory as a buffer. The direct I/O manager 360 performs the specific setup by allocating exclusive the use of the buffer space resident on each of the smart unit I/O controller for the duration of the transfer session. Only after completion of the bulk transfer session, the direct I/O manager 360 will release the buffers on each smart unit I/O controller for other usage.

With reference additionally now to FIG. 4, a logic flowchart is depicted representing a system and method for performing by the Smart personal device to discovery, registration, activation, content delivery, and deactivation of a Target device. Upon enablement by a user, the Smart personal device start the discovery step as shown in block 405 whereas the Smart personal device scans all available devices, and control devices i.e. cable modems, DSL router, Cable modem, DHCP configuration to determine past and current devices and any available configurations existed on networks. The step 405 may be performed using the proximity unit I/O controller of the smart personal device, alone or in combination with the proximity unit I/O controller of the target device. The Smart personal device is then required to scan any current Target devices from one location to another by physically moving the Smart personal device from one location to another so the Smart personal device identifies one or more Target devices located proximate to the Smart personal device uses its proximity sending device including but not limited to the RFID sensor.

Once the discovery steps are completed, the Smart personal device as shown in block 410 will register and storing relevant element of a discovered target device in the indications of target device database included in the storage area under control of the smart personal device. All discovered Target devices, including one or more discovered Target devices which cannot be enabled for the instant invention and one or more discovered Target devices which are capable of performing at least one function of the Instant invention. Furthermore the smart personal device may determine each element from all other elements in the stored indication of target devices database to determine if the element is a unique element or common element in the stored indication of target device database. A unique element consists of that the element of the indications of the target devices is different from all other elements of the indications of target devices in the database. Whereas the smart personal device predetermined common element consists of that the element of the indication of the target device is identical of another element of the indication of target device in the indications of target devices database. For example: the smart personal device discovers a first target device (a smart fan in the family room) and registered the first target device in the indication of target device database includes the following elements in the database: element #1: (Target device #1, temperature setting control element of X′0123″); element #2: (Target device #1, manufacture element of X′ABC″) in the stored indications of target devices database. In addition, the smart personal device discovers a second target device (a different smart fan in the living room). The smart personal device registers stores relevant elements of the second target device includes element #3: (target device #2, a temperature setting control element of X′0123″) and element #4: (target device #2, manufacture element of X′XYZ″) in the stored indications of target devices database. The smart personal device now determines that the first and second target devices share a predetermined common element of element #1 and element #3 as shown by element #1 (Target device #1: temperature setting control element of X′0123″) and element #3 (target device #2: a temperature setting control element of X′0123″) are common. In addition, the smart personal device also predetermines that element #2 (Target device #1: manufacture element of X′ABC″) and #4 (target device #2: manufacture element of X′XYZ″) are unique element within the indication of target devices database since element #2 and #4 is unique to any other elements of the database. The present invention may use this predetermined common element to enhance user mobility with the following smart continuity with suspend and resume capability.

After the steps of block 410, the smart personal device enters in a state to identify a Registered Target device Located Proximate to the Smart personal device as show in block 415. as shown in block 420 whereby the Smart personal device identifies a registered Target device and based on the user's desire to transfer content to such Target device. The Smart personal device proceed to perform Activation steps by remotely waking up the Target device if the Target device is in a low power sleep state or remotely configure the Target device to have a split screen mode if the Target device is currently being used by another user and if the Target device is capable to such split screen operation.

After block 420, the Smart personal device and the Target device are operable in the content delivery mode as shown by block 430 while the Smart personal device is proximate to the Target device. The contents can be sourced from the Smart personal device for the Target device to receive and display or to receive and store, or to receive and store and display on its output unit. In a reverse direction whereas the content is sourced from the Target device for the Smart personal device to receive and either display or store in its storage unit or both.

If and when the Smart personal device and the Target device which is capable of performing the direct I/O mode under the program control of its Direct I/O manager as shown by block 460 to enhance bulk content transfer by transferring the content once across its I/O bus independent of its CPU and memory with the added benefit of increased bulk content data rate while reducing power consumption of the device, Block 460 will enable the direct I/O to perform such operation.

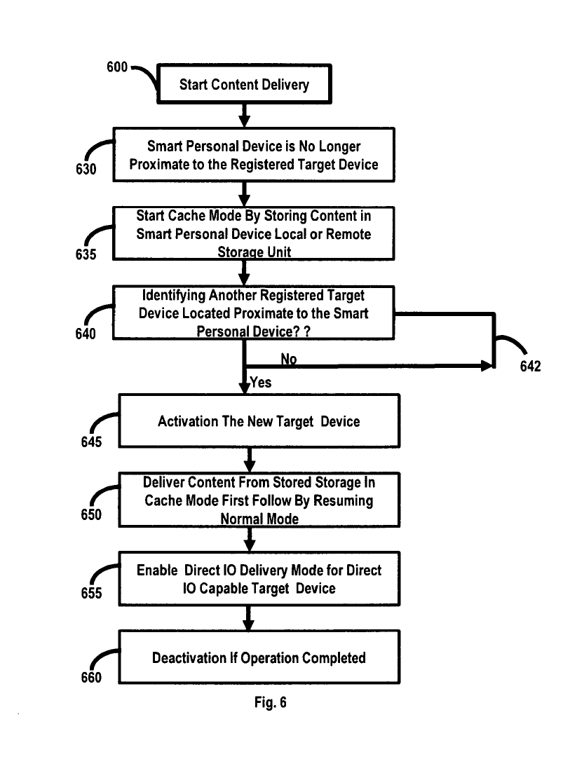

At the completion of the content delivery steps and if the Smart personal device has no further usage of the Target device, the Smart personal device will deactivate the Target device as shown in block 480. Upon completion of block 480, the Smart personal device will return to Block 415 ready state for further required operation from the user. In the event of the Smart personal device is no longer located proximate of the Target device while operating under the steps of FIG. 4, the Smart personal device will deactivate the current Target device as shown in block 480 and operating under the logic flowchart representing a system and method steps presented in FIG. 6 below.

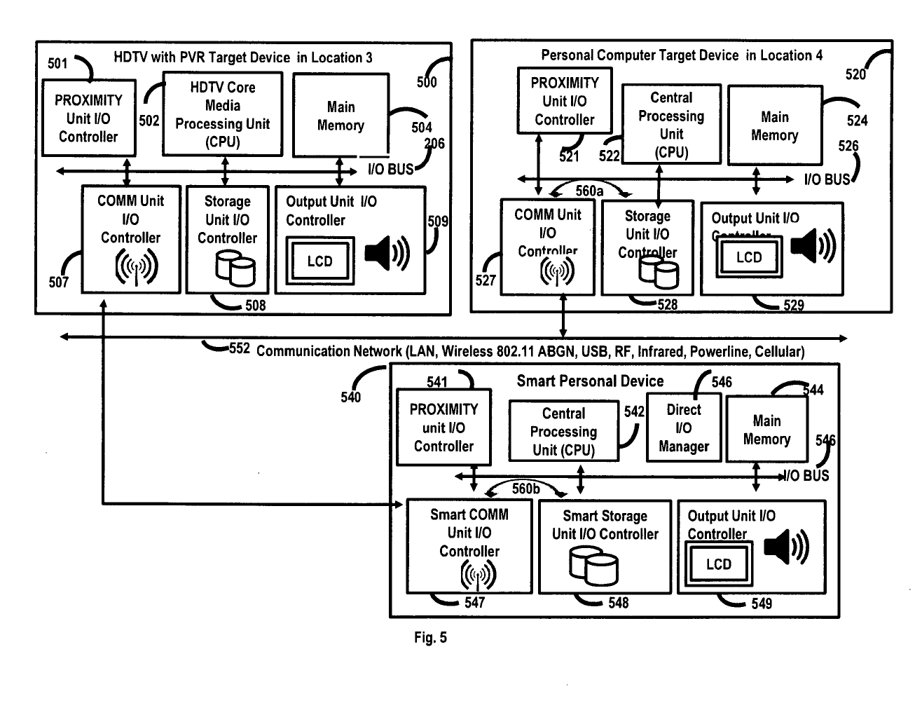

FIG. 5 is an exemplary system embodiment of a Smart personal device 540, a HDTV with PVR Target device in location 3 as show block 500 and a Personal Computer Target device in Location 4 as shown in bock 520; and each device is connected with a communication network block 522. The Smart personal device 540 which has all the capability of the Smart personal device 240 as shown in FIG. 2 with additional Direct I/O Mode capability which effective operates under program control of Direct I/O Manager block 546 to direct transfer content from block 547 and block 548 across only once using the I/O bus 546 independent of the CPU block 542 and main memory 544. Due to the high definition and high data rate requirements of these Smart personal device, the I/O units 572, 548, and 549 in block 540 of the present invention may include busmaster capability to directly transfer content between the main memory 544 and respective I/O units, independent of the CPU 542 effective under program control using the I/O bus 546; In the event of transferring bulk content i.e. a digital movie, the Smart personal device block 540 may invoke a Direct I/O transfer mode wherein effective under program control of the Direct I/O Manager 546 to transferring content directly between a pair of said I/O units via said I/O bus as show in 560b, bypassing the main memory an independent of the CPU. Using the Direct I/O Mode for a Target device improves not only the content transfer speed of the Target device but also reduces the power consumption of the CPU and Memory since these units area bypassed and inactive during the duration of content transfer. The Personal Computer Target device in Location 4 as shown in bock 520 which is similar to the Target device in block 240 in FIG. 2 with the additional Direct I/O Mode capability which effective operates under program control of Direct I/O Manager block 546 to direct transfer content from block 547 and block 548 across only once using the I/O bus 526 independent of the CPU block 522 and main memory 524. Target device 520 of the present invention is operable to meet the high definition and high data rate requirements as its I/O units 572, 528, and 529 in location 4 may including busmaster capability to direct transfer content between the main memory 424 and respective I/O units, independent of the CPU 522 effective under program control using the I/O bus 526; In the event of transferring bulk content i.e. a digital movie, the Target device in location 4 block 520 may invoke a Direct I/O transfer mode wherein effective under program control of the Direct I/O Manager 526 to transferring content directly between a pair of said I/O units via said I/O bus as show in 560a, bypassing the main memory an independent of the CPU. Using the Direct I/O Mode for a Target device improves not only the content transfer speed of the Target device but also reduces the power consumption of the CPU and Memory since these units area bypassed and inactive during the duration of content transfer.

FIG. 6 is a flow diagram of the Instant invention illustrating one flow of interaction of a Smart personal device transitioning from a first Target device in one location to a second Target device in a different location. As shown by block 600 of FIG. 6 and the Smart personal device is delivering content to a Target device and it detects that the Smart personal device is no longer proximate to the registered Target device as shown by Block 630, The Smart personal device may automatically enters a Transparent Cache Mode whereby the Smart personal device stores the ongoing live content in its local storage including but not limited to IDE, ATA, SATA hard disk drive media or USB, NAND, FLASH mass storage device or remotely to a storage medium remote from the Smart personal device such as on the network or a removable storage area as shown by block 635 without user intervention. This Transparent Cache Mode will continue as show by block 640 till the Smart personal device identifies another registered Target device located proximate to the Smart personal device with similar content delivery capability of the previous Target device or the prior Target device itself as shown by block 640. At such time, the Smart personal device will automatically without user intervention to activate the new Target device as shown by block 645 followed by delivering content from stored storage from the beginning of the stored content under the Transparent Cache Mode as shown in block 650 while the new Target device is located proximate to the Smart personal device till it reaches the end of the stored content of the Transparent Cache Mode cache content. The Smart personal device of the present invention under the block 650 may simultaneously deliver cached content to the new Target device and continually storing content under the Transparent Cache Mode as long as there is stored content of the Transparent Cache Mode which is not yet delivered to the Target device. As shown in block 655, If the Smart personal device detects either the Target device or the Smart personal device or both are Direct I/O capable device, it will under program control to activate the Direct I/O manager to enabled the Direct I/O delivery mode for these devices.

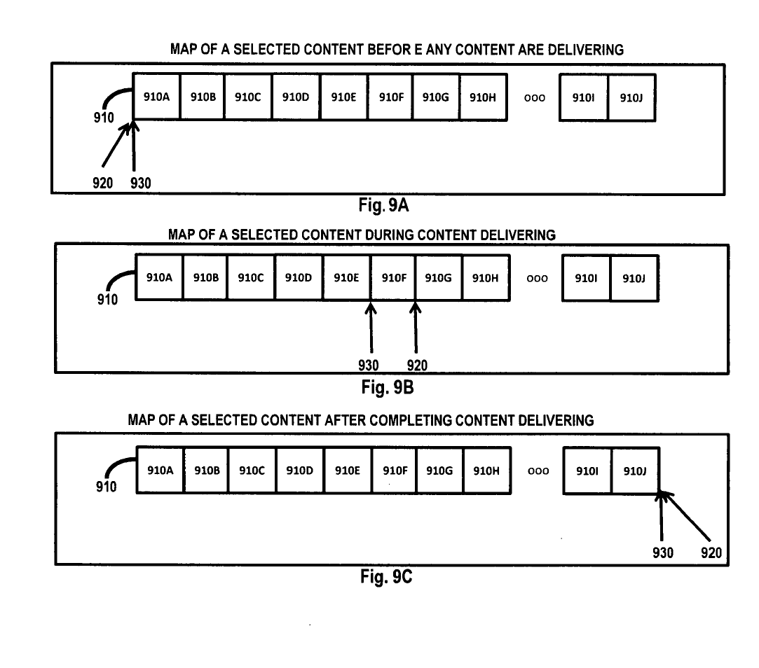

An exemplified system and method of the present invention illustrates the steps of the FIG. 6 including but not limited to a user moving around from room #1 to room #2. While the Smart personal device identifies and activates a first registered Target device located proximate to the Smart personal device at a first time and delivers content to a HDTV Target device #1 in room #1 for the duration while the Smart personal device is proximate to the Target device #1. When the Smart personal device is no longer proximate to the Target device #1 at the second time, the Smart personal device deactivates the first target device and suspends the delivery to the Target device #1 and maintains a map (see FIG. 9 and related discussion) for those portions of the selected content which has been delivered, those portions of the selected content which have been both delivered and performed by the target and those portions what are not yet delivered When the Smart personal device identifies a second registered Target device (a Personal Computer #2 of room #2) located proximate to the Smart personal device after the second time, the Smart personal device activates the new Target device and resumes delivering the remaining content using the map starting from at least one the location of the portions of the content has yet to be delivered and the location of the portions of the content yet to be performed for the duration while the Smart personal device is proximate to the new Target device. The smart personal device is operable to use the map to select the location of the portions of the content yet to be delivered or the location of the portions of the content yet to be performed is to ensure the user experiences minimal interruption of the content while the smart personal device is moving from the first location to second location. If the first target device is able to buffer up to five minutes of delivered content from the smart personal device but only performed only one minute of the delivered content before being deactivated by the smart personal device, the smart personal device may select to resume by selecting the location of the portions of the content after the first minute to the second target device. If however if the first target device requires realtime streaming of content or no buffering for the delivered content, the smart personal device may select to resume by selecting the location of the portions of content yet to be delivered. Another embodiment of the present invention illustrates the steps of the FIG. 6 including but not limited to a user listens to the content of a Digital Music System (Target device #3) in one's home whereby the Target Device #3 is a registered Target device of the Smart personal device and is located proximate to the Smart personal device whereby content was provided by a FM digital content provider and being received by Smart personal device without the need to store the content on the storage area of the Smart personal device and delivered to the Target device #3 while the Smart personal device is proximate to the Target device #3. The user leaves the home location and enter in user's automobile which has a registered digital speaker system (Target device #4) with the Smart personal device and such that the new Target device #4 has similar capability of receiving the content as of the Target device #3. While the user is leaving his home and entering the automobile, the Smart personal device in the present invention has identified that the Target device #3 is no longer proximate to the Smart personal device, it deactivates the Target device #3 and entered the Transparent Cache Mode without user action and stores FM broadcasting content at the time. At a later time when the Smart personal device identifies the Target devices #4 located proximate to the Smart personal device, it automatically activate the speaker system in the automobile without user action and deliver the stored content to the Target device #4 without interruption to the FM broadcasting content.

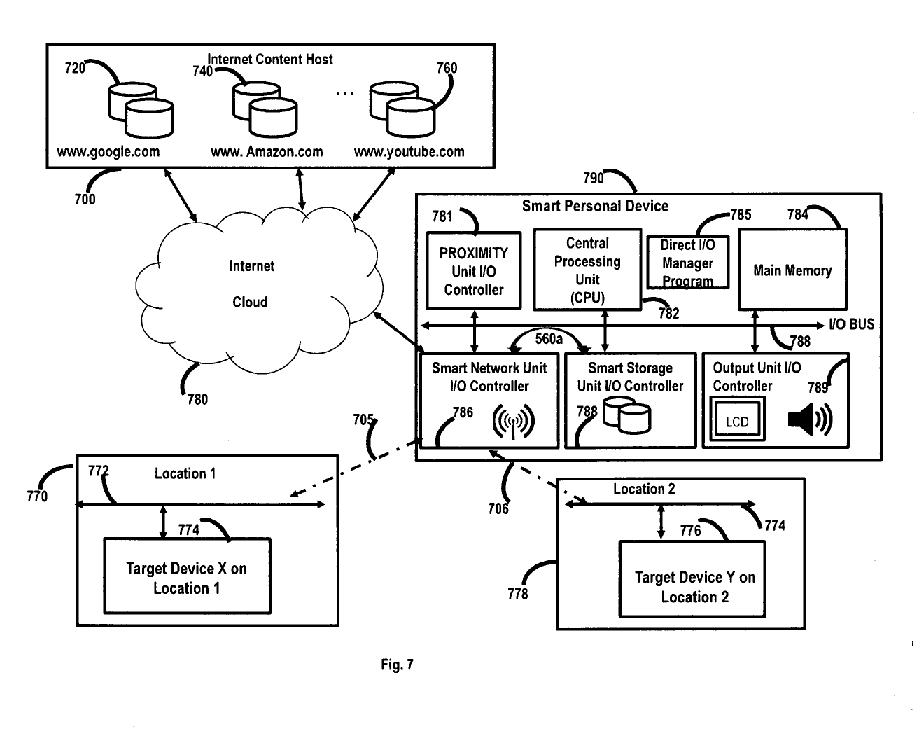

With the presence of Internet content host and web based retailers such as ebay.com and amazon.com, there is a prolific presence of web based advertisement, in the forms of banners, widgets, whereby advertisement campaign pushes these contents to device and being displayed on a specific area of the output devices i.e. CRT, LCD, HDTV of a device including but not limited to a smart phone, a personal computer while a user accessing contents from the Internet without consent of the user. Some of these advertisement contents may be interesting to a user however the majority of these web based advertisement are disruptive and each takes away productive time and processing resources away from the user. The present invention overcomes these pushed intrusions by enabling the user to specify a finite set of criteria for the Smart Device including to eliminate these un-authorized contents by removing these contents before deliver the content to the target; to use the specific filter option specified by user to first search relevant content hosts over the Internet directly or using an intermediary web services to do so. Once a desirable content is found, the Smart personal device will build a match content list and store the match content list on the Smart personal device for the user to access at one's convenience. Once a content within the matched list is selected by the user, the Smart personal device will be operated to “pull” these selected content from the content hosts and store the matched content on the storage unit of the Smart personal device for the user to access it at user's convenience either directly on the Smart personal device or access (or “push” these contents on one or more of the Target devices. In one embodiment of the present invention, the stored content will be displayed only on the target location of the output display device as if the content is being pushed by the advertisement campaign. In another embodiment of the present invention, the matched content is being reorganized by the Smart personal device so the user can access them without the restriction being shown at the original target location. An exemplified system and method of the present invention illustrates in FIG. 7 including a Smart personal device block 790 comprising a proximity unit I/O controller, a CPU 782, Main Memory 784, smart comm unit I/O controller 786, smart storage unit I/O controller, output unit I/O controller 789 and each is connected by the I/O bus 788; The Smart personal device 790 is further connected to Internet block 780 using including but not limited to a wi-fi network or an Internet service provider's data network including but not limited to dial-up, DSL, Broadband wireless access, cable internet, ISDN while accessing Internet content hosts including but not limited to block 720, 740, 760 and service providers. The smart comm unit I/O controller 786 may comprises at least one of more communication devices within which it may simultaneously connects to the internet cloud networks 780, and a local area network 772 in location 1 or a local area network 778 in location 8. When the smart personal device 790 is proximate to one of the target device within location 770 or location 778, the smart personal device 790 will activate either target device X using connection 705 or target device Y using connection 706. The smart personal device 790 is coupled to target device X on location 1 block 774 of network 772 or target device Y of location 2 block 778 on network 774, the smart personal device will activate one of the target device which is proximate the smart personal device 790 Once the smart personal device 790 activates the target device, the smart personal device may use methods of delivery contents referenced above.

One of the embodiment of present invention including continuation of content playback spanning multiple target devices based on proximity while the smart personal device transitioning from one target device to another target device is illustrated In FIG. 7.: The smart personal device 790 stores indication of target device X 770 and target device Y 778 in a storage under control of the smart personal device 790 using storage device 788 (or network device 786 to access storage within internet cloud 780). When the proximity unit controller 781 detects that target device X 770 is proximate to the smart personal device 790, the smart personal device 790 accesses a first portion of the selected content using smart storage unit controller 788 (or network unit controller 786) and delivering the content using smart network unit controller 786 to target device X 770 and rendering the selected content to the target device 770 while the target device X 770 is being detected by the proximity unit controller 781 proximate to the smart personal device 790. When proximity unit controller 781 detects the smart personal device 790 is no longer proximate to target device X 770, smart persona device 790 suspends content delivery through network unit controller 786. Thereafter, when proximity unit controller 781 detects that smart personal device 790 is proximate to target device Y 778, the smart personal device 790 resume access to storage unit controller 788 (or network unit controller 786) and deliver the second portion of the selected content to target device Y 778 and render the second portion of the selected content to target device Y 778. In addition, FIG. 7 also illustrates another embodiment of continuation of remote control of target devices based on proximity, while the smart personal device transitioning from one target device to another target device.

Furthermore, FIG. 7 illustrates another embodiment of the present invention including continuation of content creation spanning multiple devices based on proximity: The smart personal device 790 stores indication of target device X 770 in a storage under control of the smart personal device 790 using storage unit controller 788 (or using network unit controller 786 to access remote storage through internet cloud 780). The smart personal device 790 creates content and stores the content on the first portion of the selected content using storage unit controller 788 (or using network unit controller 786 to access remote storage through internet cloud 780). When the target device X 770 is detected by the proximity unit controller 781 that target device X 770 is proximate to the smart personal device 790, the smart personal device 790 suspends access and storing content in the first portion of the selected content using smart storage unit controller 788 or network unit controller 786 and enable the target device X 770 to resume access and storing content in the second portion of the selected content using network unit controller 786 and storage unit controller 788 (or accessing internet cloud 780). In addition, When the target device X 770 is detected thereafter by the proximity unit controller 781 that target device X 770 is no longer proximate to the smart personal device 790, the smart personal device 790 resume access the selected content at least one of the first portion and one of the second portion of the selected content using smart storage unit controller 788 or network unit controller 786 (or accessing internet cloud 780).

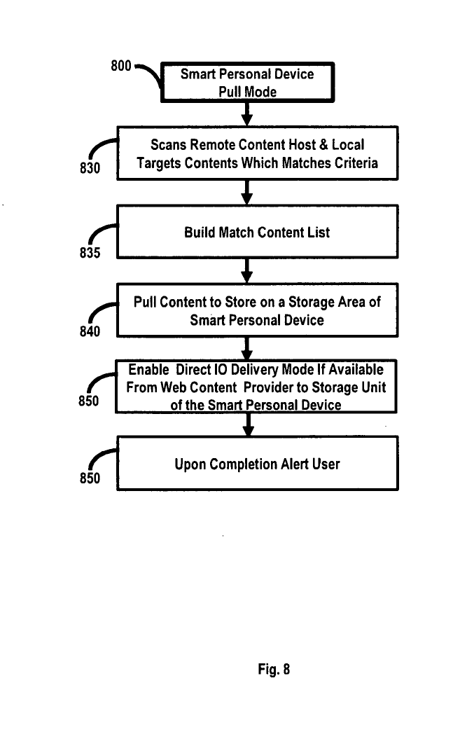

With reference additionally now to FIG. 8, a logic flowchart representing a system and method for performing the Pull Mode by the Smart personal device. Upon enablement by a user as shown on block 830, the Smart personal device start to scan Internet content host which is remotely located over the Internet and local Target device for contents which matches the selection criteria i.e. sales on a specific automobile, specific tools, travel discounts to a specific destination . . . etc. Once one of more matches are found, the smart personal device builds a Match Content List as shown on block 835 and “pull” the match content and store the content on a storage area of its local storage unit or store the content on a removable and network storage which can be accessed by the Smart personal device Block 840. If the Smart personal device is enabled with the Direct I/O Delivery Mode, Block 850, the Smart personal device will under program control to activate the Direct I/O manager 785 to enabled the Direct I/O delivery mode for pulling these match content from block 786 to block 788 across the I/O Bus 728 only once as shown by block 560a independent of the CPU 782 and main memory 784.

With reference additionally to FIG. 9, a diagram of the storage system (a map of storage at different times during the processing of data of the present invention) shows how a method and system of the present system keep track of those portions of the selected content which have been at least delivered (or delivered and performed) and those portions of the selected content which have not been delivered, thus not performed. Prior to content being selected for delivery, a map may be created to subdivide the selected content into a sequence of portions which may be represented by number of bytes, number of seconds, or number of frames shown in storage 910, consisting of stating segments number 910A and ending segment number 910J, segments which are identified with the reference numerals 910A, 910B, 910C, 910D, 910E, 910F, 910G, 910H, 910I, 910J. In addition, both a delivery pointer 920 and a performed pointer 930 are initialized and located to reference the portion number segment 910A. As the proximity device of the smart personal device identifies and activates a target device and only while the smart personal device is proximate to the target device, the communication device of the smart personal device starts delivering portions selected content by way of a sequenced segment at a time to the target device and uses the map of FIGS. 9a-9c to keep track what portions of the storage (with selected content) have been delivered to the target device as shown by FIG. 9b arrow 920, where segment 910F includes delivered content and FIG. 9b arrow 930 where segment 910E includes performed content. Additionally to track those portions which have been delivered, the smart personal device is also able to keep tract those portions which have been performed by the target device as shown by arrow 930. FIG. 9c shows at the completion of content delivery, both the arrow 920 which keep tract of those portions of the selected contents which has been delivered and arrow 930 which keep tract of those portions of the selected contents which has been performed both point to the ending segment number 910J.

The tracking of those portions which have been performed may be implemented by at least one of the method using the smart personal device alone by setting up during its configuration phase for the target device to request addition content only after a fixed number of received portions are yet to be performed or by a method of a communication method whereas the target device reports back to the smart personal device those portions of the received contents have been performed on the target device. When the smart personal device moving from a first target device of a first location to a second target device of a second location, the proximity device of the smart personal device may deactivate the first target device thus terminate the content delivery and resume the content delivery only while the smart personal device is proximate to the second target device in the second location. The smart personal device by using the map to delivery those portions of the content using at least one of the delivered pointer and the performed pointer based on a desired mode of operation including a user preference, a desire quality of non-interruption of the content delivery while the smart personal device is moving from the first target device to the second device. The present invention in consideration of a user who prefer to not miss any contents while moving from a first location to a second different location may configure the smart personal device to resume content delivery from the arrow 930 (including deliver data from segment 910F as show in FIG. 9b even though the said segment has already delivered to the previous device in the first location) which keep tract of those portions of the selected contents which has been performed by the previous device from the first location. The present invention may enable a user who prefer not to care of certain missed contents while moving from a first location to a second different location may configure the smart personal device to resume content delivery from the arrow 920 (including deliver data from segment 910G as show in FIG. 9b since content 910A-910F has already delivered to the previous device in the first location) which keep tract of those portions of the selected contents which has been delivered by the previous device from the first location.

Those skilled in the art will understand that the present invention has been described in illustrative form only and that many modifications are possible without departing from the spirit of the resent invention. For example, smart personal device in the present invention is a hardware and software component which is integrated or embedded with a portable device including but not limited to a smart phone, a personal computer, a laptop, a netbook, a GPS, a personal multimedia player, video MP3 player, a portable radio or a tablet PC. A smart personal device can as well be a standalone, special purpose device which comprises one or more of the features described in the above paragraphs either alone or in a combination of other features. Additionally, ad sifting system and method for matched content, turning off power for these target device no longer in proximate of the smart personal device. Those skilled in the art will also appreciate that some of the features described can be employed to advantage without the corresponding use of other features. For example, the use of RFID is desirable for discovering a target device, though not required if the smart personal device is equipped with the use of a pattern recognition feature, or an optical component, or a bar code component either alone or in combination with the use of the RFID component to discover a target device. It will be understood that the present invention is described in connection with various systems such as communications protocols which are in use today, but the present invention is not restricted to the presently-used communications protocols. Also, many additional features can be added to the present invention including but not limited to a usage timer which meters either the time used on the smart device by the user, or the network bandwidth used for delivering content, a storage used to store the content . . . etc. In addition, actions taken when the smart personal device located proximate to the target device can include or replace with a location specific feature such a GPS. Accordingly, the foregoing description should be considered as merely a description of the present invention and not in limitation of it, as the scope of the present invention is defined by the claims which follow.

What is claimed is:

1. A content delivery apparatus, comprising:
a data processing device;
a storage under control of the data processing device;
selected content stored in the storage include a first portion followed by a second portion, said second portion not including the first portion;
an indication of first and second target devices stored in the storage;
a proximity device coupled to the data processing device;
the data processing device being configured to respond to a detection, by the proximity device, that the data processing device is proximate to a first target device included in the indication of first and second target devices, to access the first portion of the selected content and the first target device at a first time;
the data processing device being further configured to respond to a detection at a second time, by the proximity device, that the data processing device is no longer proximate to the first target device, suspend access of the first portion of the selected content; and
the data processing device being further configured to respond to a detection at a third time, by the proximity device, that the data processing device is proximate to a second target included in the indication of first and second target devices and access the second portion of the selected content and the second target device.

2. The content delivery apparatus as set forth in claim 1, wherein the first target device accesses and renders the first portion of the selected content at the first time; and second target device accesses and renders the second portion of the selected content at the third time.

3. The content delivery apparatus as set forth in claim 1, wherein the first target device accesses and stores information in the first portion of the selected content at the first time; and the second target device accesses and stores information at least in the second portion of the selected content at the third time.

4. The content delivery apparatus as set forth in claim 1, wherein the second portion of the selected content is accessed without user intervention at the third time.

5. A method of content delivery comprising the steps of:
(a) selecting content stored in a storage area under control of a data processing device, the data processing device including a proximity device and the selected content including a first portion followed by a second portion and the second portion not including the first portion;
(b) storing an indication of first and second target devices in the storage area;
(c) accessing the first portion of the selected content and a first target device included in the indication of first and second target devices while the proximity device detects that the data processing device is proximate to the first target device at a first time;
(d) suspending accessing the first portion of the selected content when the proximity device detects that first data processing device is no longer proximate to the first target device at a second time; and
(e) after step (d), resuming accessing the second portion of the selected content and a second target device included in the indication of first and second target devices while the proximity detects that data processing device is proximate to the second target device at a third time.

6. The method of claim 5, wherein the step of accessing the first portion of the selected content and the first target device at the first time includes rendering the first portion of the selected content to the first target device; and the step of accessing the second portion of the selected content and the second target device at the third time includes rendering the second portion of the selected content to the second target device.

7. The method of claim 5, wherein the step of resuming accessing the second portion of the selected content and the second target device at the third time occurs without user intervention.

8. The method of claim 5, wherein the step of accessing the first portion of the selected content includes the step of storing information in the first portion of the selected content; and the step of accessing the second portion of the of the selected content at the third time includes the step of storing information at least in the second portion of the selected content.

9. The method of claim 5, wherein the step of accessing the second portion of the selected content and a second target device further includes the steps of storing information in a storage area of the second target device at the third time.

10. A method comprising:
(a) storing in a storage area under control of a data processing device an indication of a target device, the data processing device including a proximity device;
(b) selecting content in the storage area, the selected content including a first portion and a second portion with the first portion follows the second portion and the second portion not including the first portion;
(c) accessing the first portion of the selected content by the data processing device at a first time;
(d) detecting, by the proximity device, that a target device included in the indication of the target device is proximate to the data processing device at a second time; and
(e) after step (d), suspending accessing the first portion of the selected content by the data processing device and enabling, the target device to access the second portion of the selected content at a third time.

11. The method of claim 10, wherein step of accessing the first portion of the selected content includes rendering the first portion of the selected content to a display device at the first time; and the step of enabling the target device to access the second portion of the selected content includes rendering the second portion of the selected content to the target device at the third time.

12. The method of claim 10, wherein the step of accessing the first portion of the selected content includes the step of storing information at the first time; and the step of enabling the target device to access the second portion of the selected content at the third time includes the step of storing information at least in the second portion of the selected content.

13. The method of claim 10, further comprising the step of detecting using the proximity device that the target device is no longer proximate to the data processing device after the third time, and the method also includes the step of resuming accessing at least one of the first portion and the second portion of the selected content by the data processing device.

14. The method of claim 10, wherein the step of enabling the target device to access the second portion of the selected content is predetermined by the first data processing device using the indication of the target device.

15. The method of claim 10 wherein the step of enabling the target device to access the second portion of the selected content occurs without user intervention.

16. A content delivery apparatus, comprising:
a data processing device and a target device;
a storage under control of the data processing device;
selected content stored in the storage including a first portion and a second portion, said second portion following the first portion and said second portion not including the first portion;
an indication of the target device stored in the storage;
a proximity device coupled to the data processing device;
the data processing device being configured to access the first portion of a selected content at a first time;
the data processing device being further configured to respond to a detection, by the proximity device, that the data processing device is proximate to the target device included in the indication of the target device, and suspending accessing the first portion of the selected content by the data processing device at a second time; and
the data processing device being further configured to enable the target device to access to the second portion of the selected content at the third time.

17. The apparatus of claim 16 further comprising the data processing device being further configured to respond to detection, by the proximity device that the data processing device is no longer proximate to the target device after the third time, and access at least one of the first portion and the second portion of the selected content by the data processing device.

18. The apparatus of claim 16, wherein the data processing device access and store information in the first portion of the selected content at the first time; and the target device access and store information at least in the second portion of the selected content at the third time.

19. The apparatus of claim 16, wherein the data processing device access and render the first portion of the selected content to a display device of the data processing device at the first time; and the data processing device access and render the second portion of the selected content to the target device at the third time.

20. The apparatus of claim 16, wherein the apparatus enables the target device to access the second portion of the selected content without user intervention at the third time.

21. The apparatus of claim 16, wherein the data processing device enables the second target device to access the second portion of the selected content is predetermined by the data processing device using the indication of the target devices.

22. A method of content delivery comprising the steps of:
(a) storing indication of first and second target devices in a storage area under control of a data processing device, the data processing device including a proximity device;
(b) selecting stored content, the selected content comprising a first portion followed by a second portion and second portion not including the first portion;
(c) delivering the first portion of the selected content to a first target device included in the first and second target devices while the proximity device is detecting that data processing device is proximate to the first target device;
(d) suspending the delivery of the first portion of the selected content to the first target device when the proximity device detects that first data processing device is no longer proximate to the first target device at a second time; and
(e) after the second time, resuming delivering the second portion of the selected content while the proximity device is detecting that data processing device is proximate to a second target device included in the indication of first and target devices.

23. The method of claim 22, further comprising the step of determining elements included in of the indication of the first and second target devices comprises at least one common element and at least one unique element; and said at least one common element is included in the first portion of the selected content and the second portion of the selected content.

24. The method of claim 23 wherein the at least one common element delivered to the first target device and the second target device is predetermined using the indication of the first and target devices and used exclusively for the first and second target devices.

25. The method of claim 22 wherein the step of suspending the delivery of the first portion of the selected content to the first target device further comprises the steps of capturing and storing one common element from the first target device at the second time, and delivering the stored common element to the second target device at the third time while the data processing device is proximate to the second target device.

26. The method of claim 22 wherein resuming delivering the second portion to the second target device at the second location occurs without user intervention.
